(19) United States
(12) Patent Application Publication
(10) Pub. No.: US 2026/0099586 A1
(43) Pub. Date: Apr. 9, 2026

(54) VIRTUAL MACHINE HOST FAST-SWITCH BETWEEN STANDARD AND CONFIDENTIAL VM HOSTING MODES

(71) Applicant: Microsoft Technology Licensing, LLC, Redmond, WA (US)

(72) Inventors: Alexander Daniel GREST, Redmond, WA (US); Benjamin Christopher PYE, North Vancouver (CA); Michael MCREYNOLDS, Seattle, WA (US); Jonathan Edward LANGE, Seattle, WA (US); Kevin XU, Bellevue, WA (US); Naga Kiran GOVINDARAJU, Medina, WA (US); Olivia Doan Anh THAI, Seattle, WA (US); Pushkar Vijay Chitnis, Bothell, WA (US); Venkat Rao MANDAVA, Sammamish, WA (US); Bruce J. SHERWIN, JR., Woodinville, WA (US); Matthew Cushman BODDEWYN, Seattle, WA (US)

(21) Appl. No.: 18/906,508

(22) Filed: Oct. 4, 2024

(51) Int. Cl. G06F 21/54; G06F 12/14; G06F 21/57

(52) U.S. Cl. CPC G06F 21/54; G06F 12/1408; G06F 21/572

(57) ABSTRACT

A fast-switch mode is disclosed for switching a virtual machine (VM) host computer system between standard and confidential VM hosting modes. During initialization of a hypervisor during cold-boot of a VM host, the host enables the fast-switch mode, including allocating a contiguous memory portion to an address translation lookup table. The VM host initially operates in the standard VM hosting mode without a secure virtualization feature enabled. The VM host later switches to the confidential VM hosting mode by activating the secure virtualization feature and utilizing the address translation lookup table. Alternatively, The VM host initially operates in the confidential VM hosting mode without the secure virtualization feature enabled, and later switches to the standard VM hosting mode by deactivating the secure virtualization feature. In one example, the address translation lookup table is a reverse map table (RMP), and the secure virtualization feature is secure encrypted virtualization-secure nested paging (SEV-SNP).

### BACKGROUND

Hypervisor-based virtualization technologies allocate portions of a computer system's physical resources (e.g., processor, physical memory, storage resources) into separate partitions and execute software within each partition. Therefore, hypervisor-based virtualization technologies facilitate the creation of guest virtual machines (VMs) that each execute guest software, such as an operating system (OS) and applications executing therein. A computer system that hosts guest VMs is commonly called a VM host or a VM host node.

While hypervisor-based virtualization technologies can take various forms, many use an architecture comprising a type-one, or bare-metal, hypervisor that has direct access to hardware and operates in a separate execution environment from all other software in the computer system. A type-one hypervisor creates a root (or host) partition (e.g., a host VM) and one or more child (or guest) partitions (e.g., guest VMs). Each partition comprises an isolated slice of the underlying hardware of the VM host, such as memory and processor resources. The root partition executes a host OS and a host virtualization stack that manages the child partitions. Thus, the hypervisor grants the root partition greater access to the hypervisor and hardware resources than it does to child partitions. Other hypervisor-based architectures comprise a type-two, or hosted, hypervisor that executes within the context of an underlying OS and creates one or more child partitions.

Taking HYPER-V from MICROSOFT CORPORATION as one example, the HYPER-V hypervisor is a type-one hypervisor making up the lowest layer of a HYPER-V stack. The HYPER-V hypervisor provides basic functionality for dispatching and executing virtual processors for guest VMs. The HYPER-V hypervisor takes ownership of hardware virtualization capabilities (e.g., second-level address translation processor extensions such as rapid virtualization indexing from ADVANCED MICRO DEVICES or extended page tables from INTEL; an input/output (I/O) memory management unit that connects a direct memory access-capable I/O bus to main memory; processor virtualization controls). The HYPER-V hypervisor also provides a set of interfaces to allow a HYPER-V host stack within a root partition to leverage these virtualization capabilities to manage guest VMs. The HYPER-V host stack provides general functionality for guest VM virtualization (e.g., memory management, guest VM lifecycle management, device virtualization).

In addition to isolating guest partitions from each other, some hypervisor-based virtualization technologies further operate to isolate guest VM state (e.g., virtual processor registers, memory) from the root partition (and a host OS executing within) and, in some cases, even from the hypervisor itself. To achieve the foregoing, these virtualization technologies introduce a security boundary between at least the hypervisor and the host virtualization stack. This security boundary restricts which guest VM resources can be accessed by the host OS (and, in turn, the host virtualization stack) to ensure the integrity and confidentiality of a guest VM. In this document, such a guest VM is referred to as a confidential VM (CVM), while a conventional guest VM lacking these additional protections is referred to as a standard VM (SVM). Examples of technologies that enable CVMs include hardware-based memory isolation and encryption technologies such as trusted domain extensions (TDX) from INTEL or secure encrypted virtualization with secure nested paging (SEV-SNP) from ADVANCED MICRO DEVICES (AMD). TDX provides hardware-based isolation and memory encryption for VMs. SEV-SNP protects the confidentiality and integrity of entire VMs by encrypting their memory and enforcing strict memory access controls through hardware-enforced integrity checks.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, implemented in a virtual machine (VM) host computer system (VM host) that includes a processor system and a memory, including: determining, during initialization of a hypervisor during cold-boot of the VM host, the VM host is to operate in a fast-switch mode for switching between a first VM hosting mode and a second VM hosting mode; enabling the fast-switch mode at the VM host, including allocating a contiguous portion of the memory to an address translation lookup table; proceeding to operate in the first VM hosting mode after enabling the fast-switch mode, including hosting a first VM with a secure virtualization feature disabled in the processor system; determining the VM host is to be switched to the second VM hosting mode; and switching to the second VM hosting mode, including enabling the secure virtualization feature in the processor system, wherein the secure virtualization feature utilizes the address translation lookup table within the contiguous portion of the memory.

In some aspects, the techniques described herein relate to methods, systems, and computer program products, implemented in a VM host computer system that includes a processor system and a memory, including: determining, during initialization of a hypervisor during cold-boot of the VM host and based on reading a first configuration value stored on a storage medium in the VM host, the VM host is to operate in a fast-switch mode for switching between a standard VM hosting mode and a confidential VM hosting mode; enabling the fast-switch mode at the VM host, including allocating a contiguous portion of the memory to an address translation lookup table; proceeding to operate in the confidential VM hosting mode after enabling the fast-switch mode, including hosting a confidential VM with a secure virtualization feature enabled in the processor system, wherein the secure virtualization feature utilizes the address translation lookup table within the contiguous portion of the memory; determining, based on reading a second configuration value stored on the storage medium in the VM host, that the VM host is to be switched to the standard VM hosting mode; and switching to the standard VM hosting mode, including disabling the secure virtualization feature in the processor system.

In some aspects, the techniques described herein relate to methods, systems, and computer program products, implemented in a VM host computer system that includes a processor system and a memory, including: determining, during initialization of a hypervisor during cold-boot of the VM host, that the VM host is to operate in a fast-switch mode for switching between a standard VM hosting mode and a confidential VM hosting mode; enabling the fast-switch mode at the VM host, including allocating a contiguous portion of the memory to a reverse map table (RMP); proceeding to operate in the standard VM hosting mode after enabling the fast-switch mode, including hosting a standard VM with a secure encrypted virtualization-secure nested paging (SEV-SNP) feature disabled in the processor system; determining that the VM host is to be switched to the confidential VM hosting mode after operating in the standard VM hosting mode; switching to the confidential VM hosting mode, including enabling the SEV-SNP feature in the processor system, wherein the SEV-SNP feature utilizes the RMP within the contiguous portion of the memory; determining that the VM host is to be switched to the standard VM hosting mode after operating in the confidential VM hosting mode; and switching to the standard VM hosting mode, including disabling the SEV-SNP feature in the processor system.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIGS. 1A-1B illustrate an example of a virtual machine (VM) host that supports a fast-switch mode that allows the VM host to switch between a standard VM (SVM) hosting mode and a confidential VM (CVM) hosting mode without rebooting the VM host;

FIG. 2 illustrates an example of a mode manager at a hypervisor;

FIG. 3 illustrates an example of a node converter at a root partition;

FIG. 4 illustrates an example of managing SVM modes and CVM modes across one or more clusters; and

FIG. 5 illustrates a flow chart of an example of a method for operating a VM host in a fast-switch mode that allows the VM host to switch between an SVM hosting mode and a CVM hosting mode without rebooting the VM host.

### DETAILED DESCRIPTION

Secure virtualization technologies can increase security, but they also reduce performance, e.g., due to memory encryption, address translation lookups, etc. So, a virtual machine (VM) host usually runs either with these technologies disabled and only hosts standard VMs (SVMs) or with these technologies enabled and only hosts confidential VMs (CVMs). But for overall load management (e.g., at a data center), this often means that a VM host has unused capacity, e.g., because the available VMs don't match the available CVM VM hosts and SVM VM hosts well. So, changing a VM host's workload from SVMs to CVMs, or vice versa, can improve operational efficiency. However, changing from SVM mode to CVM mode or vice versa has required a full restart of the VM host, causing an unacceptable downtime of the VM host.

At least some embodiments described herein provide a fast-switch mode that allows a VM host to switch between an SVM hosting mode and a CVM hosting mode without rebooting the VM host. This enables faster and more efficient switches between different hosting modes, as well as improved cluster management. The fast-switch mode provides various technical benefits, such as reducing the downtime and overhead of switching between hosting modes, increasing the responsiveness and availability of VM hosts, optimizing the utilization and allocation of hardware resources, and enhancing the performance and reliability of VM applications.

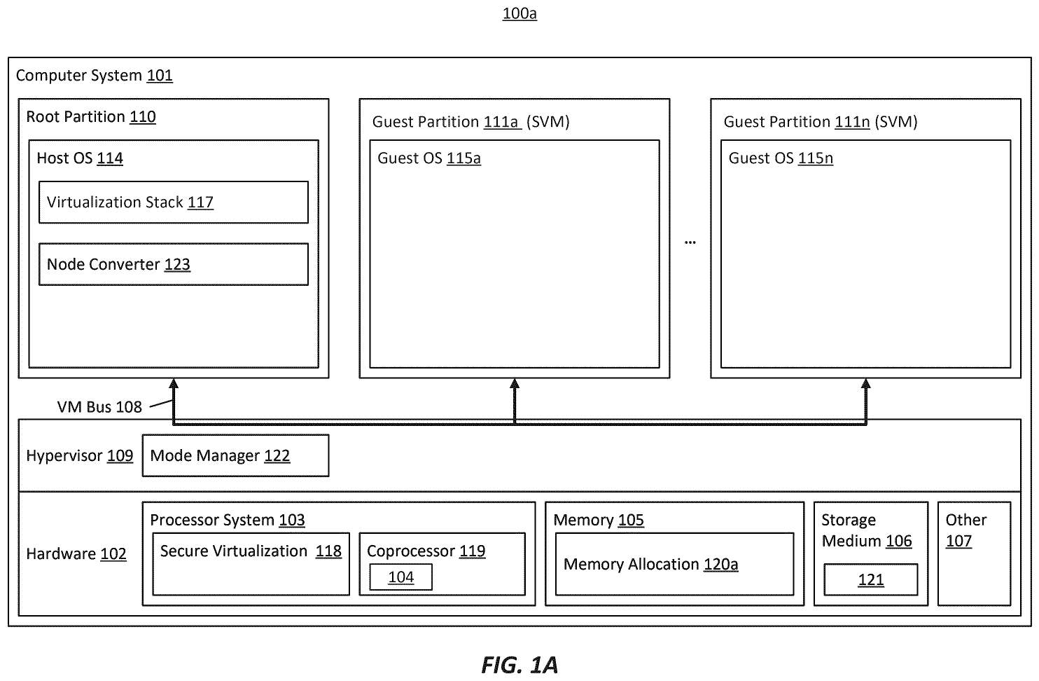

FIGS. 1A-1B illustrate an example of a computer architecture 100 (computer architecture 100a, FIG. 1A; computer architecture 100b, FIG. 1B) that facilitates a VM host supporting a fast-switch mode allowing the VM host to switch between an SVM hosting mode and a CVM hosting mode without rebooting the VM host. Referring to FIGS. 1A-1B, computer architecture 100a/b includes a computer system 101 comprising hardware 102. Examples of hardware 102 include a processor system 103 (e.g., a single processor or a plurality of processors), a coprocessor system 119, a memory 105 (e.g., system or main memory), a storage medium 106 (e.g., a single computer-readable storage medium, or a plurality of computer-readable storage media). As shown, computer system 101 can include a variety of hardware (other 107), such as a network interface (e.g., one or more network interface cards) for interconnecting to one or more other computer systems.

In computer architecture 100a/b, a hypervisor 109 executes directly on hardware 102. In general, the hypervisor 109 partitions hardware resources (e.g., processor system 103, memory 105, I/O resources) among a root partition 110, within which a host OS 114 executes, as well as one or more guest partitions 111, or guest VMs, (e.g., guest partition 111a to guest partition 111n) within which corresponding guest OSs 115 execute (e.g., guest OS 115a in guest partition 111a to guest OS 115n in guest partition 111n). The hypervisor 109 also enables regulated communications between partitions via a VM bus 108. The host OS 114 includes a virtualization stack 117, which manages guest VMs (e.g., memory management, VM guest lifecycle management, device virtualization) via one or more application program interface (API) calls to the hypervisor 109 via VM bus 108.

In embodiments, computer architecture 100a/b can host both SVMs and CVMs. FIG. 1A (computer architecture 100a) shows guest partitions 111 as SVMs, while FIG. 1B (computer architecture 100b) shows guest partitions 111 as CVMs—with diagonal lines indicating that the memory contents of these CVMs are not visible to hypervisor 109 and root partition 110. In computer architecture 100a, processor system 103 includes a secure virtualization component 118 that facilitates the creation of CVMs, by providing memory isolation and encryption capabilities for use by hypervisor 109. In some examples, secure virtualization component 118 comprises one or more components implementing trusted domain extensions (TDX) technology from INTEL. In other examples, secure virtualization component 118 comprises one or more components implementing secure nested paging (SEV-SNP) technology from ADVANCED MICRO DEVICES (AMD). Other implementations of secure virtualization component 118 are also possible.

While secure virtualization technologies provide a great measure of security, they come with a performance cost, e.g., due to memory encryption or traversing an address translation lookup table 120b during memory accesses. For example, testing has shown that enabling secure virtualization technologies at a VM host while hosting an SVM can impact the VM's performance by up to 30%, compared to when that SVM is hosted at the same VM host with secure virtualization technologies disabled. As a result, a given VM host is generally operated either with secure virtualization technologies disabled and hosting only SVMs, or with secure virtualization technologies enabled and hosting only CVMs. However, in the context of overall load management (e.g., at a data center), this often means that a given VM host has wasted capacity, e.g., because the available set of VMs to be hosted don't cleanly fit the available CVM VM hosts and SVM VM hosts. As a result, switching a given VM host's workload from SVMs to CVMs, or vice versa, can beneficially impact operational efficiency. For example, given a current (or anticipated) set of VMs operated (or to be operated) at a given VM host cluster, altering the mix of SVM hosts and CVM hosts within the cluster may improve the fit of VMs to VM hosts, and better utilize hosting capacity within the cluster. However, particularly when disabling secure virtualization technologies, this has required a full “cold” boot of the VM host. A cold boot is a full boot of a computer system as if from a completely powered-off state, that includes an initialization of system firmware and an enumeration and initialization of connected hardware devices. Performing a full cold boot of a VM host typically leads to significant (e.g., multi-minute) downtime of the VM host. Thus, cold-booting a computer system to perform a secure virtualization technologies mode switch results in a significant (e.g., multi-minute) loss of VM host resources within the cluster during the switch.

To address these drawbacks, the embodiments herein introduce a mode manager 122 and a node converter 123, which enable computer system 101 to switch quickly between an SVM hosting mode (SVM mode) and a CVM hosting mode (CVM mode) without needing to perform a full cold boot to make the switch. These embodiments are built on the insight that preparing computer system 101 at cold boot time for using the CVM mode, even when the computer system 101 may operate in the SVM mode initially with secure virtualization technologies disabled, can substantially reduce the time and complexity of switching modes later. By discovering secure virtualization component 118 and making a memory allocation 120a for storing an address translation lookup table 120b used by secure virtualization component 118 during its initial cold boot process, without actually enabling secure virtualization component 118, computer system 101 can avoid the need to reboot when switching from SVM mode to CVM mode, saving many minutes of downtime. Additionally, embodiments can disable secure virtualization component 118 to switch from CVM to SVM mode. Computer system 101 can thus dynamically switch between hosting SVMs and CVMs with minimal downtime, regardless of the initial boot mode.

These embodiments are particularly useful for technologies, such as SEV-SNP, that utilize an address translation lookup table 120b stored in memory 105. For example, SEV-SNP utilizes a reverse map table (RMP) as a version of an address translation lookup table 120b to keep track of the mapping between guest-physical addresses (GPAs) and host-physical addresses (HPAs) and, generally, requires a contiguous chunk of physical memory pages in system memory (e.g., memory 105), sized based on the total size of the system memory. In one example, RMP entries are eight bytes (64 bits) each, and an RMP entry corresponds to each memory page in system memory. So, for instance, if memory 105 is 64 gigabytes in size, with four kilobytes (4096 bytes) page sizes, then a set of contiguous physical memory pages (memory allocation 120a) totaling 128 megabytes would be needed for the RMP. VM host computer systems may have many terabytes of memory, requiring even larger contiguous memory allocations. For example, a VM host with four terabytes of system memory would require eight gigabytes of contiguous physical memory pages. Notably, contiguous allocations of this large size may be difficult, or even impossible, to achieve on a system that has previously executed workloads.

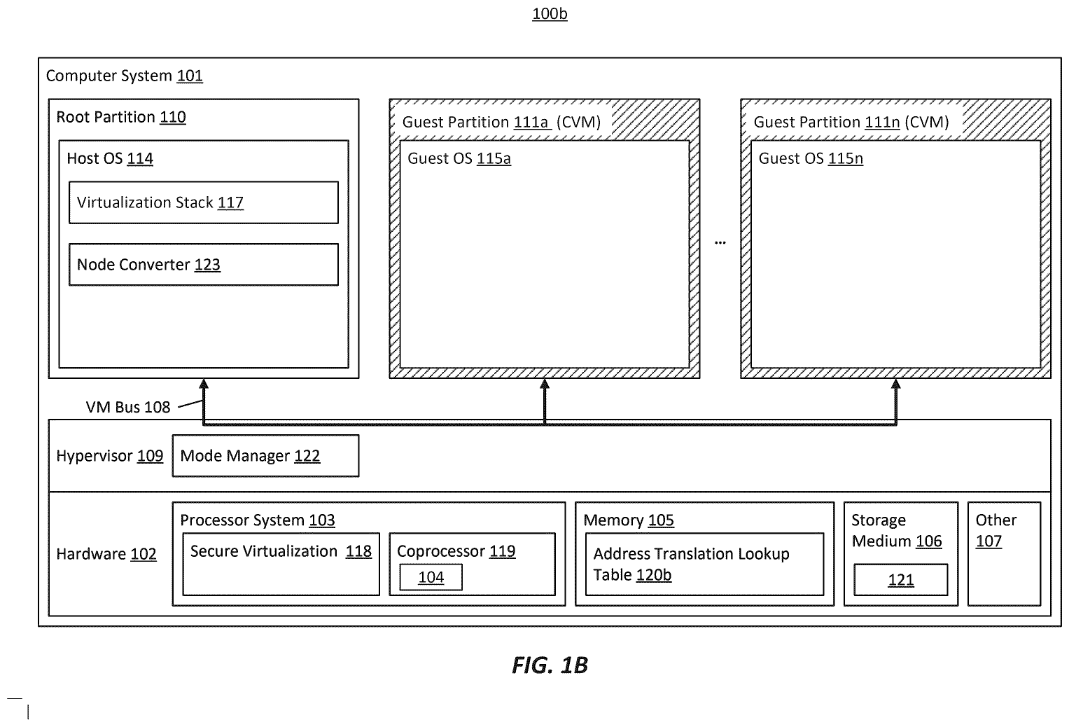

FIG. 2 illustrates an example 200 of the mode manager 122 of FIGS. 1A-1B. Each component of the mode manager 122 depicted in FIG. 2 represents various functionalities that the mode manager 122 may implement under the embodiments described herein. These components—including their identity and arrangement—are presented merely as an aid in describing example embodiments of mode manager 122.

In example 200, mode manager 122 includes a mode determiner 201 that determines a target operating mode of hypervisor 109, e.g., based on a setting 121 stored in storage medium 106. The setting 121 may indicate whether hypervisor 109 should start in SVM or CVM mode. Mode determiner 201 reads the setting 121 and configures the hypervisor 109 accordingly. In some embodiments, setting 121 is set by node converter 123 or an administrator. In embodiments, mode determiner 201 operates at the cold boot of computer system 101 and during a subsequent mode change. Examples of setting 121 include a registry key, a boot parameter, and a file on disk.

In example 200, mode manager 122 also includes fast-switch mode enabler 202 that, on a cold boot, configures computer system 101 to be ready for the activation of secure virtualization component 118, even if hypervisor 109 initially enters the SVM mode.

In example 200, fast-switch mode enabler 202 includes a memory allocator 203 that reserves a memory allocation 120a in memory 105 for storing an address translation lookup table 120b used by secure virtualization component 118. In embodiments, memory allocator 203 performs this allocation regardless of the initial operating mode of hypervisor 109 so that a contiguous chunk of physical memory pages is reserved for the address translation lookup table 120b in case of a mode switch to CVM mode.

In example 200, fast-switch mode enabler 202 also includes a co-processor initializer 204 that discovers and initializes a co-processor 119, if any are available to supplement the primary processor, that is used by secure virtualization component 118 to perform secure encryption and decryption operations on the memory pages of the CVMs. In embodiments, co-processor initializer 204 performs this discovery/initialization during the cold boot process of computer system 101, regardless of the initial operating mode of hypervisor 109. In embodiments, discovery/initialization of co-processor 119 includes, for example, updating firmware 104 at the co-processor 119 and discovering secure virtualization platform state.

In some processor architectures, secure virtualization component 118 utilizes a security mode on the primary processor (e.g., processor system 103). The security mode involves the execution of dedicated security firmware on the primary processor itself. For example, INTEL TDX includes a central processing unit (CPU) mode called “Secure-Arbitration Mode” (SEAM). In these processor architectures, fast-switch mode enabler 202 may perform a discovery/initialization of this security mode during the cold boot process of computer system 101, including uploading firmware to the primary processor, and/or discovering a security mode state. In embodiments, discovery/initialization of this security mode could be performed as an alternative to the discovery and initialization of a co-processor 119 or in addition to the discovery and initialization of a co-processor 119.

In example 200, mode manager 122 also includes a hypervisor initializer 205. On cold boot, the hypervisor initializer 205 initializes hypervisor 109 into the SVM mode or the CVM mode indicated by setting 121. Later, on a node switch initiated by node converter 123, hypervisor initializer 205 re-initializes hypervisor 109 into the SVM mode or the CVM mode indicated by setting 121. In embodiments, when re-initializing hypervisor 109, the hypervisor initializer 205 calls the processor system 103 to enable or disable secure virtualization component 118, depending on the target mode, and restarts hypervisor 109 in the target mode without fully restarting the computer system 101. In some implementations, the time it takes to restart the hypervisor 109 is measured in seconds or tens of seconds. This contrasts with a full cold boot of computer system 101, measured in minutes, as would have been required for a mode switch previously.

In some embodiments, such as computer system 101, the hypervisor is a type-one hypervisor where hypervisor 109 and host OS 114 are separate entities. In these embodiments, hypervisor initializer 205 may trigger a servicing operation, such as a kernel soft reboot (KSR), that tears down root partition 110 (including host OS 114) and then re-creates root partition 110 and boots the host OS 114 after initializing the hypervisor 109 into the target mode, all without performing a cold boot of the computer system. In many instances, a KSR can be accomplished in tens of seconds versus the many minutes a cold boot would have required. In other embodiments, the hypervisor is a type-two hypervisor where the hypervisor is hosted by the host OS. In these embodiments, hypervisor initializer 205 re-initializes the hypervisor without restarting the host OS.

In embodiments, such as when secure virtualization component 118 is SEV-SNP, mode manager 122 may perform additional operations in connection with the operation of hypervisor initializer 205, such as configuring model-specific registers (MSRs) that control SEV features, specify RMP base and end addresses (e.g., corresponding to memory allocation 120a), and/or configuring RMP properties..

Thus, mode manager 122 enables computer system 101 to quickly switch between an SVM hosting mode (e.g., example 100a, in which computer system 101 hosts SVMs) and a CVM hosting mode (e.g., example 100b, in which computer system 101 hosts CMVs) by preparing for the mode switch during the cold boot process and re-initializing the hypervisor 109 and the host OS 114 as needed. Mode manager 122 is operable whether initially booting into SVM mode or CVM mode and can adjust the operating mode of hypervisor 109 based on setting 121 or a user input.

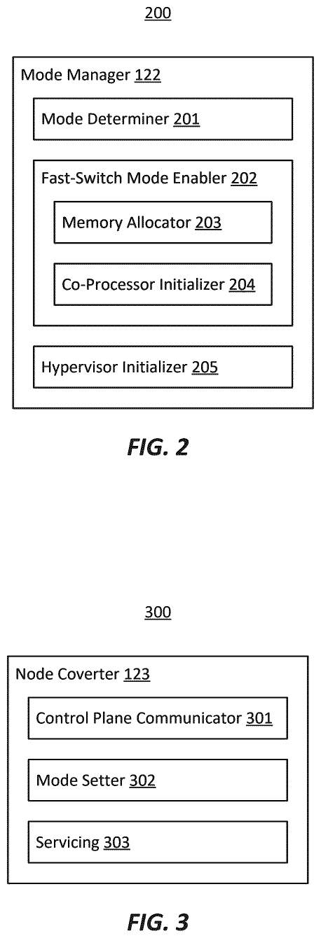

FIG. 3 illustrates an example 300 of the node converter 123 of FIGS. 1A-1B. Each component of node converter 123 depicted in FIG. 3 represents various functionalities that node converter 123 may implement under the embodiments described herein. These components—including their identity and arrangement—are presented merely as an aid in describing example embodiments of node converter 123.

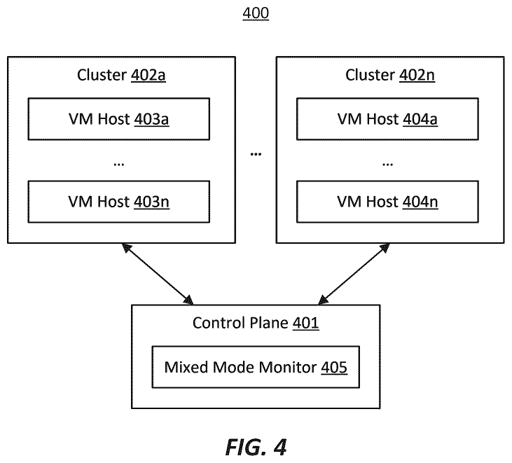

In example 300, node converter 123 includes a control plane communicator 301 that communicates with a control plane, as described later in reference to FIG. 4. In general, control plane communicator 301 receives instructions from a mixed mode monitor 405 at a control plane regarding the mode (e.g., SVM mode or CVM mode) in which computer system 101 should operate.

In example 300, node converter 123 also includes a mode setter 302 that sets setting 121 to a value indicating which mode (e.g., SVM mode, shown in example 100a, or CVM mode, shown in example 100b) in which computer system 101 should operate. In embodiments, mode setter 302 may set setting 121 based on an instruction from control plane communicator 301 or based on an administrator request. In various embodiments, mode setter 302 sets setting 121 directly or instructs mode manager 122 to set setting 121.

In example 300, node converter 123 also includes a servicing component 303 that instructs mode manager 122 to initiate a runtime mode switch, based on the stored indication specified in setting 121. In embodiments, node converter 123 may also orchestrate a servicing operation, such as a KSR, that tears down root partition 110 (including host OS 114) and then re-creates root partition 110 and boots the host OS 114 after initializing the hypervisor 109 into the target mode specified in setting 121.

FIG. 4 illustrates an example 400 of managing SVM modes and CVM modes across one or more clusters. In some embodiments, a control plane 401 is configured to oversee the operation and configuration of multiple clusters of VM hosts, such as cluster 402a to cluster 402n. Each cluster includes a plurality of VM hosts, such as VM host 403a to VM host 403n in cluster 402a and VM host 404a to VM host 404n in cluster 402n. The control plane 401 may communicate with each VM host via a network, such as a local area network, a wide area network, or the Internet.

The control plane 401 includes a mixed mode monitor 405, which determines a desired mix of VM hosts operating in the SVM mode in each cluster, and VM hosts operating in CVM mode in each cluster based on the current and/or anticipated VM workloads. For example, mixed mode monitor 405 may analyze resource utilization, performance, security requirements, and service level agreements (SLAs) of the VMs assigned to each cluster and decide how many VM hosts should operate in SVM mode or CVM mode to meet the demand and optimize the efficiency of the cluster(s). In embodiments, mixed mode monitor 405 also predicts the future workloads of the VMs based on historical data, trends, or user input and plans ahead for the mode switches that may be needed in each cluster.

The mixed mode monitor 405 may initiate the mode switches by sending instructions to the node converter 123 of each selected VM host. For example, the mixed mode monitor 405 may identify an empty VM host (i.e., a VM host that does not have any active VMs running on it) and instruct that VM host's node converter 123 to switch the VM host from SVM mode to CVM mode or vice versa. Alternatively, the mixed mode monitor 405 may migrate the VMs away from a VM host to another VM host in the same or a different cluster and then instruct the node converter 123 to switch the mode of the emptied VM host. Notably, migrating VMs to facilitate a VM host mode transition can help manage overall resource utilization in a VM hosting cluster by ensuring that there is an appropriate mix of SVM VM hosts and CVM VM hosts in the cluster, given the mix of SVMs and CVMs that need to be operated on the cluster.

In some embodiments, the mixed mode monitor 405 may also monitor the status and availability of the VM hosts in each cluster and detect any failures, errors, or anomalies that may affect the operation of the VMs. The mixed mode monitor 405 may take corrective actions, such as switching the mode of a VM host from SVM to CVM or vice versa, migrating the VMs to another VM host, or restarting a VM host, to ensure the reliability and security of the VMs. The mixed mode monitor 405 may also provide feedback and reports to the users or administrators of the VMs, such as the resource consumption, performance, and security metrics of the VMs and the VM hosts.

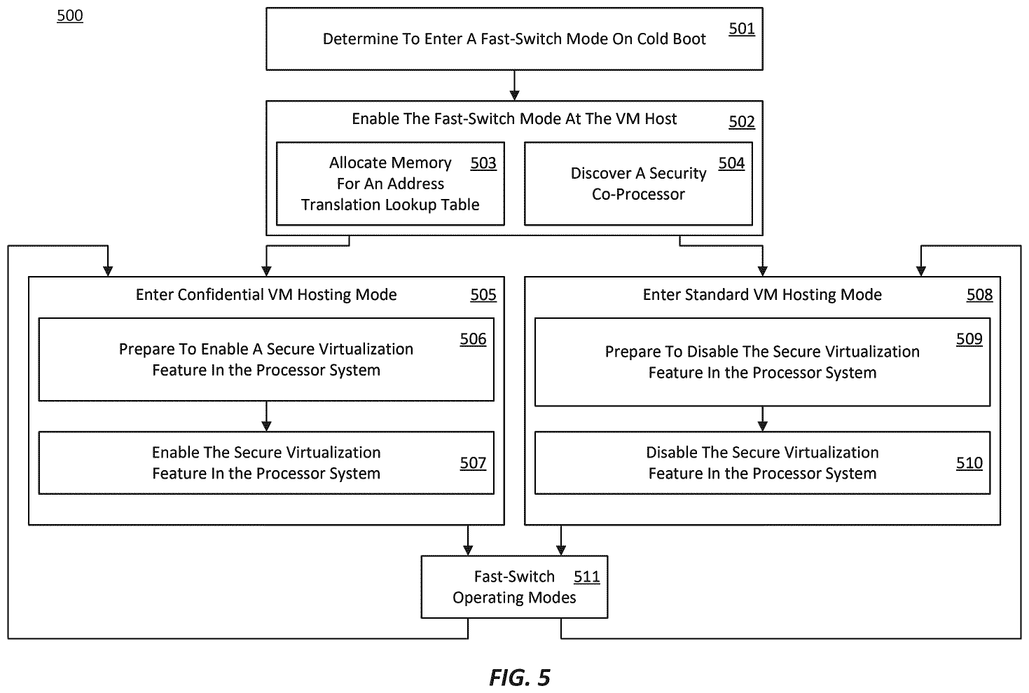

Embodiments are now described in connection with FIG. 5, which illustrates a flow chart of an example method 500 for operating a VM host in a fast-switch mode that allows the VM host to switch between an SVM hosting mode and a CVM hosting mode without rebooting the VM host. In embodiments, instructions for implementing method 500 are encoded as computer-executable instructions (e.g., mode manager 122, node converter 123) stored on a computer storage medium (e.g., storage medium 106) that are executable by a processor (e.g., processor system 103) to cause a computer system (e.g., computer system 101) to perform method 500.

The following discussion now refers to a method and method acts. Although the method acts are discussed in specific orders or are illustrated in a flow chart as occurring in a particular order, no order is required unless expressly stated or required because an act is dependent on another act being completed prior to the act being performed.

Referring to FIG. 5, in embodiments, method 500 comprises an act 501 of determining to enter a fast-switch mode on cold boot. In some embodiments, act 501 determines, during initialization of a hypervisor during cold boot of the VM host, that the host is to operate in a fast-switch mode for switching between an SVM hosting mode and a CVM hosting mode. For example, during a cold boot of computer system 101, mode determiner 201 uses setting 121 to determine a desired operating mode for hypervisor 109. In embodiments, setting 121 is stored in storage medium 106, and in act 501, determining that the VM host is to operate in the fast-switch mode includes reading a configuration value stored on a storage medium in the VM host.

Method 500 also comprises an act 502 of enabling the fast-switch mode at the VM host. For example, fast-switch mode enabler 202 enables fast-switch mode at computer system 101. In embodiments, act 502 comprises an act 503 of allocating memory for an address translation lookup table. In some embodiments, act 503 allocates a contiguous portion of the memory to an address translation lookup table. For example, memory allocator 203 reserves a memory allocation 120a in memory 105 for storing an address translation lookup table 120b (e.g., RMP) used by secure virtualization component 118. Even if hypervisor 109 initially operates in the SVM mode, by performing act 503, there is a guarantee that a contiguous chunk of physical memory pages is available for address translation lookup table 120b in case of a mode switch to CVM mode.

In embodiments, act 502 also comprises an act 504 of discovering a security co-processor. In some embodiments, act 504 comprises discovering a security coprocessor used by the secure virtualization feature. For example, co-processor initializer 204 discovers and initializes a co-processor 119 used by secure virtualization component 118 to perform secure encryption and decryption operations on the memory pages of CVMs. In embodiments, act 504 includes one or more of uploading firmware 104 to the co-processor 119 or discovering secure virtualization platform state.

Additionally, or alternatively, in embodiments, act 502 also comprises discovering a CPU security mode used by the secure virtualization feature. For example, fast-switch mode enabler 202 discovers and initializes a security mode such as SEAM from INTEL. In embodiments, act 504 includes one or more of uploading firmware to the processor system 103 or discovering security mode state.

After an initial cold-boot over computer system 101, method 500 comprises booting hypervisor 109 into either the SVM mode or the CVM mode, based, e.g., on setting 121. Thus, method 500 branches to either an act 505 of entering a confidential VM hosting mode or an act 508 of entering a standard VM hosting mode.

In some embodiments, method 500 branches to act 505 (initially entering CVM mode). In some embodiments, act 505 comprises operating in the CVM hosting mode after enabling the fast-switch mode, including hosting a CVM with a secure virtualization feature enabled in the processor system. In these embodiments, the secure virtualization feature utilizes the address translation lookup table within the contiguous portion of the memory.

In embodiments, act 505 comprises an act 506 of preparing to enable the secure virtualization feature in the processor system. For example, mode manager 122 may configure processor registers (e.g., MSRs) and/or memory locations, update firmware 104 at co-processor 119, update firmware at processor system 103 (e.g., for a security mode such as INTEL SEAM), etc., to prepare computer system 101 for enabling secure virtualization component 118.

In embodiments, act 505 also comprises an act 507 of enabling a secure virtualization feature in the processor system. In some embodiments, act 507 comprises the hypervisor making a call into a firmware in the processor system. For example, hypervisor initializer 205 calls processor system 103 to enable secure virtualization component 118. In embodiments, once the secure virtualization component 118 has been enabled, operating in the CVM hosting mode includes creating a root partition (e.g., root partition 110) at the VM host, booting a host OS (e.g., host OS 114) within the root partition, and creating a CVM (e.g., guest partition 111a, FIG. 1A).

In other embodiments, method 500 branches to act 508 (initially entering SVM mode). In some embodiments, act 508 comprises, after enabling the fast-switch mode, operating in the SVM hosting mode, including hosting an SVM with the secure virtualization feature disabled in the processor system. As shown in embodiments, act 508 may comprise act 509 of preparing to disable the secure virtualization feature in the processor system and act 510 of disabling the secure virtualization feature. However, in embodiments, act 508 and act 509 are only performed on a switch from CVM mode to SVM mode, as discussed later. In embodiments, operating in the SVM hosting mode includes creating a root partition (e.g., root partition 110) at the VM host, booting a host OS (e.g., host OS 114) within the root partition, and creating an SVM (e.g., guest partition 111a, FIG. 1B).

Method 500 also comprises an act 511 of fast-switching operating modes. In some embodiments, such as when method 500 previously branched to act 505, act 511 comprises determining that the VM host is to be switched to the SVM hosting mode after operating in the CVM hosting mode and switching to the CPVM hosting mode, including disabling the secure virtualization feature in the processor system. Based on act 511, method 500 proceeds to act 508. Unlike after a cold boot of computing system 101, when performing act 508, method 500 includes act 509 of preparing to disable the secure virtualization feature in the processor system and act 510 of disabling the secure virtualization feature in the processor system.

In embodiments, act 509 includes tearing down a CVM before disabling the secure virtualization feature. For example, based on an instruction from control plane 401, node converter 123 empties the computer system 101 of all CVMs in preparation for disabling the secure virtualization feature in the processor system.

In embodiments, act 510 includes the host OS calling the hypervisor and the hypervisor disabling the secure virtualization feature in the processor system. For example, servicing component 303 instructs mode manager 122 to disable secure virtualization component 118, and then hypervisor initializer 205 calls processor system 103 to disable secure virtualization component 118. In embodiments, hypervisor initializer 205 calls processor system 103 to disable secure virtualization component 118, which includes hypervisor 109 making a call into a firmware in processor system 103, such as overall firmware of processor system 103 or co-processor 119. In embodiments, after disabling secure virtualization component 118, method 500 includes operating an SVM after switching to the SVM hosting mode.

In other embodiments, such as when method 500 previously branched to act 508, act 511 comprises determining that the VM host is to be switched to the CVM hosting mode after operating in the SVM hosting mode and switching to the CVM hosting mode, including enabling the secure virtualization feature in the processor system. Then, the secure virtualization feature utilizes the address translation lookup table within the contiguous portion of the memory. As shown, based on act 511, method 500 proceeds to act 505—including act 505 of preparing to enable the secure virtualization feature and act 506 of enabling the secure virtualization feature.

In embodiments, act 506 includes tearing down an SVM before enabling the secure virtualization feature in the processor system. For example, based on an instruction from control plane 401, node converter 123 empties the computer system 101 of all SVMs in preparation for enabling the secure virtualization feature in the processor system. In embodiments, act 506 additionally, or alternatively, includes configuring processor registers (e.g., MSRs) and/or memory locations, updating firmware 104 at co-processor 119, updating firmware at processor system 103, etc., to prepare computer system 101 for enabling secure virtualization component 118. In embodiments, act 506 additionally, or alternatively, includes tearing down the root partition before enabling the secure virtualization feature in the processor system. For example, servicing component 303 orchestrates a KSR of hypervisor 109. In embodiments, act 506 additionally, or alternatively, includes setting a configuration value at the VM host. For example, mode manager 122 or node converter 123 sets setting 121 to indicate that hypervisor 109 should start in CVM mode. In embodiments, act 506 additionally, or alternatively, includes updating the firmware in the security coprocessor and/or updating the firmware in the CPU.

In embodiments, act 507 comprises the hypervisor making a call into a firmware in the processor system to enable a secure virtualization feature in the processor system. For example, hypervisor initializer 205 calls processor system 103 to enable secure virtualization component 118. In embodiments, once the secure virtualization component 118 has been enabled, operating in the CVM hosting mode includes one or more of creating a root partition (e.g., root partition 110) at the VM host, booting a host OS (e.g., host OS 114) within the root partition, and creating a CVM (e.g., guest partition 111a, FIG. 1A).

In embodiments, act 511 can be performed any number of times during the operation of computer system 101, enabling computer system 101 to switch between SVM mode and CVM mode dynamically any number of times.

Alternatively or in addition to the other examples described herein, examples include any combination of the following:
Clause 1. A method implemented in a virtual machine (VM) host computer system (VM host) that includes a processor system and a memory, comprising: determining, during initialization of a hypervisor during cold-boot of the VM host, the VM host is to operate in a fast-switch mode for switching between a first VM hosting mode and a second VM hosting mode; enabling the fast-switch mode at the VM host, including allocating a contiguous portion of the memory to an address translation lookup table; proceeding to operate in the first VM hosting mode after enabling the fast-switch mode, including hosting a first VM with a secure virtualization feature disabled in the processor system; determining the VM host is to be switched to the second VM hosting mode; and switching to the second VM hosting mode, including enabling the secure virtualization feature in the processor system, wherein the secure virtualization feature utilizes the address translation lookup table within the contiguous portion of the memory.
Clause 2. The method of clause 1, when operating in the first VM hosting mode also includes: creating a root partition at the VM host; and booting a host operating system (OS) within the root partition.
Clause 3. The method of clause 2, wherein switching to the second VM hosting mode includes: tearing down the root partition before enabling the secure virtualization feature in the processor system; and re-creating the root partition after enabling the secure virtualization feature in the processor system.
Clause 4. The method of clause 2, wherein switching to the second VM hosting mode includes: setting a configuration value at the VM host; and restarting the hypervisor at the VM host, wherein, based on the configuration value, the hypervisor enables the secure virtualization feature in the processor system.
Clause 5. The method of clause 1, wherein switching to the second VM hosting mode includes tearing down the first VM before enabling the secure virtualization feature in the processor system.
Clause 6. The method of clause 1, wherein enabling the secure virtualization feature in the processor system comprises the hypervisor making a call into a firmware in the processor system.
Clause 7. The method of clause 1, wherein the method further comprises operating a second VM after switching to the second VM hosting mode.
Clause 8. The method of clause 1, wherein determining the VM host is to operate in the fast-switch mode includes reading a first configuration value stored on a storage medium in the VM host and determining the VM host is to be switched to the second VM hosting mode includes reading a second configuration value stored on the storage medium in the VM host.
Clause 9. The method of clause 1, wherein enabling the fast-switch mode at the VM host also includes: discovering a security coprocessor to support the secure virtualization feature; and loading a firmware into the security coprocessor.
Clause 10. The method of clause 9, wherein switching to the second VM hosting mode also includes updating the firmware in the security coprocessor.
Clause 11. The method of clause 1, wherein enabling the fast-switch mode at the VM host also includes: discovering a security management operating mode of a central processing unit, and loading security firmware for execution in the security management operating mode.
Clause 12. The method of clause 11, wherein switching to the second VM hosting mode also includes updating the security firmware to be executed in that security management operating mode.
Clause 13. The method of clause 1, wherein the address translation lookup table is a reverse map table (RMP), and the secure virtualization feature is secure encrypted virtualization-secure nested paging (SEV-SNP).
Clause 14. The method of clause 1, wherein the first VM hosting mode is a standard VM hosting mode and the second VM hosting mode is a confidential VM hosting mode.
Clause 15. A method implemented in a virtual machine (VM) host computer system (VM host) that includes a processor system and a memory, comprising: determining, during initialization of a hypervisor during cold-boot of the VM host and based on reading a first configuration value stored on a storage medium in the VM host, the VM host is to operate in a fast-switch mode for switching between a standard VM hosting mode and a confidential VM hosting mode; enabling the fast-switch mode at the VM host, including allocating a contiguous portion of the memory to an address translation lookup table; proceeding to operate in the confidential VM hosting mode after enabling the fast-switch mode, including hosting a confidential VM with a secure virtualization feature enabled in the processor system, wherein the secure virtualization feature utilizes the address translation lookup table within the contiguous portion of the memory; determining, based on reading a second configuration value stored on the storage medium in the VM host, that the VM host is to be switched to the standard VM hosting mode; and switching to the standard VM hosting mode, including disabling the secure virtualization feature in the processor system.
Clause 16. The method of clause 15, when operating in the standard VM hosting mode also includes: creating a root partition at the VM host; and booting a host operating system (OS) within the root partition.
Clause 17. The method of clause 16, wherein switching to the standard VM hosting mode includes: the host OS calling the hypervisor; and the hypervisor disabling the secure virtualization feature in the processor system based on the host OS calling the hypervisor.
Clause 18. The method of clause 15, wherein switching to the standard VM hosting mode includes tearing down the confidential VM before disabling the secure virtualization feature in the processor system.
Clause 19. The method of clause 14, wherein the address translation lookup table is a reverse map table (RMP), and the secure virtualization feature is secure encrypted virtualization-secure nested paging (SEV-SNP).
Clause 20. A virtual machine (VM) host computer system (VM host), comprising: a processor system; a memory; and a computer storage medium that stores computer-executable instructions that are executable by the processor system to at least: determine, during initialization of a hypervisor during cold-boot of the VM host, that the VM host is to operate in a fast-switch mode for switching between a standard VM hosting mode and a confidential VM hosting mode; enable the fast-switch mode at the VM host, including allocating a contiguous portion of the memory to a reverse map table (RMP); proceed to operate in the standard VM hosting mode after enabling the fast-switch mode, including hosting a standard VM with a secure encrypted virtualization-secure nested paging (SEV-SNP) feature disabled in the processor system; determine that the VM host is to be switched to the confidential VM hosting mode after operating in the standard VM hosting mode; switch to the confidential VM hosting mode, including enabling the SEV-SNP feature in the processor system, wherein the SEV-SNP feature utilizes the RMP within the contiguous portion of the memory; determine that the VM host is to be switched to the standard VM hosting mode after operating in the confidential VM hosting mode; and switch to the standard VM hosting mode, including disabling the SEV-SNP feature in the processor system.

Embodiments of the disclosure comprise or utilize a special-purpose or general-purpose computer system (e.g., computer system 101) that includes computer hardware, such as, for example, a processor system (e.g., processor system 103) and system memory (e.g., memory 105), as discussed in greater detail below. Embodiments within the scope of the present disclosure also include physical and other computer-readable media for carrying or storing computer-executable instructions and/or data structures. Such computer-readable media can be any media accessible by a general-purpose or special-purpose computer system. Computer-readable media that store computer-executable instructions and/or data structures are computer storage media (e.g., storage medium 106). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which, when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more CPUs, one or more graphics processing units (GPUs), or one or more neural processing units (NPUs).

In some embodiments, the disclosed systems and methods are practiced in network computing environments with many types of computer system configurations, including, as examples, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, and switches. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an operating system (OS) and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a virtual machine (VM) host computer system (VM host) that includes a processor system and a memory, comprising:
determining, during initialization of a hypervisor during cold-boot of the VM host, the VM host is to operate in a fast-switch mode for switching between a first VM hosting mode and a second VM hosting mode;
enabling the fast-switch mode at the VM host, including allocating a contiguous portion of the memory to an address translation lookup table;
proceeding to operate in the first VM hosting mode after enabling the fast-switch mode, including hosting a first VM with a secure virtualization feature disabled in the processor system;
determining the VM host is to be switched to the second VM hosting mode; and
switching to the second VM hosting mode, including enabling the secure virtualization feature in the processor system, wherein the secure virtualization feature utilizes the address translation lookup table within the contiguous portion of the memory.

2. The method of claim 1, when operating in the first VM hosting mode also includes:
creating a root partition at the VM host; and
booting a host operating system (OS) within the root partition.

3. The method of claim 2, wherein switching to the second VM hosting mode includes:
tearing down the root partition before enabling the secure virtualization feature in the processor system; and
re-creating the root partition after enabling the secure virtualization feature in the processor system.

4. The method of claim 2, wherein switching to the second VM hosting mode includes:
setting a configuration value at the VM host; and
restarting the hypervisor at the VM host, wherein, based on the configuration value, the hypervisor enables the secure virtualization feature in the processor system.

5. The method of claim 1, wherein switching to the second VM hosting mode includes tearing down the first VM before enabling the secure virtualization feature in the processor system.

6. The method of claim 1, wherein enabling the secure virtualization feature in the processor system comprises the hypervisor making a call into a firmware in the processor system.

7. The method of claim 1, wherein the method further comprises operating a second VM after switching to the second VM hosting mode.

8. The method of claim 1, wherein determining the VM host is to operate in the fast-switch mode includes reading a first configuration value stored on a storage medium in the VM host and determining the VM host is to be switched to the second VM hosting mode includes reading a second configuration value stored on the storage medium in the VM host.

9. The method of claim 1, wherein enabling the fast-switch mode at the VM host also includes:
discovering a security coprocessor to support the secure virtualization feature; and
loading a firmware into the security coprocessor.

10. The method of claim 9, wherein switching to the second VM hosting mode also includes updating the firmware in the security coprocessor.

11. The method of claim 1, wherein enabling the fast-switch mode at the VM host also includes:
discovering a security management operating mode of a central processing unit, and
loading security firmware for execution in the security management operating mode.

12. The method of claim 11, wherein switching to the second VM hosting mode also includes updating the security firmware to be executed in that security management operating mode.

13. The method of claim 1, wherein the address translation lookup table is a reverse map table (RMP), and the secure virtualization feature is secure encrypted virtualization-secure nested paging (SEV-SNP).

14. The method of claim 1, wherein the first VM hosting mode is a standard VM hosting mode and the second VM hosting mode is a confidential VM hosting mode.

15. A method implemented in a virtual machine (VM) host computer system (VM host) that includes a processor system and a memory, comprising:
determining, during initialization of a hypervisor during cold-boot of the VM host and based on reading a first configuration value stored on a storage medium in the VM host, the VM host is to operate in a fast-switch mode for switching between a standard VM hosting mode and a confidential VM hosting mode;
enabling the fast-switch mode at the VM host, including allocating a contiguous portion of the memory to an address translation lookup table;
proceeding to operate in the confidential VM hosting mode after enabling the fast-switch mode, including hosting a confidential VM with a secure virtualization feature enabled in the processor system, wherein the secure virtualization feature utilizes the address translation lookup table within the contiguous portion of the memory;
determining, based on reading a second configuration value stored on the storage medium in the VM host, that the VM host is to be switched to the standard VM hosting mode; and
switching to the standard VM hosting mode, including disabling the secure virtualization feature in the processor system.

16. The method of claim 15, when operating in the standard VM hosting mode also includes:
creating a root partition at the VM host; and
booting a host operating system (OS) within the root partition.

17. The method of claim 16, wherein switching to the standard VM hosting mode includes:
the host OS calling the hypervisor; and
the hypervisor disabling the secure virtualization feature in the processor system based on the host OS calling the hypervisor.

18. The method of claim 15, wherein switching to the standard VM hosting mode includes tearing down the confidential VM before disabling the secure virtualization feature in the processor system.

19. The method of claim 15, wherein the address translation lookup table is a reverse map table (RMP), and the secure virtualization feature is secure encrypted virtualization-secure nested paging (SEV-SNP).

20. A virtual machine (VM) host computer system (VM host), comprising:
a processor system;
a memory; and
a computer storage medium that stores computer-executable instructions that are executable by the processor system to at least:
determine, during initialization of a hypervisor during cold-boot of the VM host, that the VM host is to operate in a fast-switch mode for switching between a standard VM hosting mode and a confidential VM hosting mode;
enable the fast-switch mode at the VM host, including allocating a contiguous portion of the memory to a reverse map table (RMP);
proceed to operate in the standard VM hosting mode after enabling the fast-switch mode, including hosting a standard VM with a secure encrypted virtualization-secure nested paging (SEV-SNP) feature disabled in the processor system;
determine that the VM host is to be switched to the confidential VM hosting mode after operating in the standard VM hosting mode;
switch to the confidential VM hosting mode, including enabling the SEV-SNP feature in the processor system, wherein the SEV-SNP feature utilizes the RMP within the contiguous portion of the memory;
determine that the VM host is to be switched to the standard VM hosting mode after operating in the confidential VM hosting mode; and
switch to the standard VM hosting mode, including disabling the SEV-SNP feature in the processor system.
